(19) United States
(12) Patent Application Publication
(10) Pub. No.: US 2023/0001410 A1
(43) Pub. Date: Jan. 5, 2023

(54) LID FOR A MICROTITER PLATE

(71) Applicant: Analytik Jena GmbH, Jena (DE)

(72) Inventors: Claus Knippschild, Jena (DE); Jan Kaiser, Stollberg (DE); Robert Möller, Jena (DE); Christian Paulenz, Jena (DE)

(21) Appl. No.: 17/311,687

(22) PCT Filed: Nov. 28, 2019
(86) PCT No.: PCT/EP2019/082856

§ 371 Date: Jun. 8, 2021

(30) Foreign Application Priority Data
Dec. 6, 2018 (DE) 10 2018 131 123.0

(51) Int. Cl. B01L 3/00; G01N 21/03

(52) U.S. Cl. CPC B01L 3/50853; G01N 21/0303; B01L 2300/0654

(57) ABSTRACT

The present disclosure relates to a lid for a microtiter plate, which has a plurality of cavities arranged on a top of the microtiter plate and serve for receiving samples, wherein the lid is securable on the microtiter plate such that it covers of the microtiter plate. The lid has a basic body, which is embodied such that at least in regions, which are located above the cavities when the lid is on the microtiter plate, it is transmissive for light of predeterminable wavelength, and wherein the lid includes at least one closure element, which is embodied and/or arranged in such a manner that it closes at least one of the cavities in the microtiter plate when the lid is on the microtiter plate.

The present invention relates to a lid for a microtiter plate, to a microtiter plate with a lid of the invention, as well as to an automatable laboratory working space with a microtiter plate of the invention.

Microtiter plates are applied in a wide variety of fields, for example, in the fields of biotechnology and molecular biology, for investigating a number of samples. Especially, microtiter plates are used for the polymerase chain reaction, especially in the well known thermocyclers of the state of the art. Microtiter plates comprise, as a rule, a frame with a plate, in which a plurality of cavities are present. The cavities are frequently also referred to as “wells”. The number of cavities is variable. The applied material must be suitably selected for the analytical step to be performed. In the case of thermally controlled process steps, for example, an effective temperature stability of the material is indispensable.

For preventing cross contaminations between the individual cavities of a microtiter plate, it is known to use sealing films, which are secured to the top of the plate, especially bonded, and must be removed, in order to enable access to the samples arranged in the cavities. Another known measure for preventing cross contaminations resides in the application of suitably embodied rubber mats, which have cones underneath, which serve to seal the cavities in the state established on the microtiter plate. Additionally known are plastic strips with plugs, which can be pushed into the cavities of the microtiter plates.

In automatable plants, frequently used are sealing means (heat sealers), in which a film is placed on the microtiter plate and using a heating procedure and a pressing force securely bonded with the microtiter plate. Such an apparatus is known, for example, from US2018/0149668A1.

Known from US2012/0058516A1, for example, is a sealing film for a microtiter plate. The film is arranged in a frame, especially a stackable frame, wherein the frame is adapted to the dimensions of the microtiter plate. In order to be able to seal the individual cavities of the microtiter plate, the frame with sealing film is applied on the microtiter plate and heat sealed to the plate. The film can, on the one hand, be secured in the frame in such a manner that it remains there after the heating. It is, however, likewise possible so to embody the frame and sealing film such that the frame can be removed after the heating procedure.

Such solutions require, however, always a separate apparatus for sealing the individual cavities of the microtiter plate.

DE10205977A1 describes a work station and a thermocycler. In the work station, the thermocycler can perform a sealing of the microtiter plate with a suitable film. The film can be arranged on the microtiter plate automatically in the thermocycler. Such is achieved by a holder assembly, for example, a frame, in which the film is held under tension to span the area of the frame.

Disclosed in EP1 161994A2 are, in turn, a microtiter plate and a lid for a microtiter plate, which are embodied for fulfilling increased sealing requirements. The microtiter plate includes a frame and a plate having a plurality of cavities. Arranged between the lid and the plate is at least one seal of an elastic material connected securely with the lid and/or the plate, in order to seal the cavities, when the lid is arranged on the plate. The lid can, for example, be engageable with the frame of the microtiter plate.

Starting from the state of the art, an object of the invention is to provide an opportunity for preventing possibly occurring cross contaminations microtiter plates in especially easy manner.

The object is achieved by a lid as defined in claim 1 for a microtiter plate, by a microtiter plate as defined in claim 13, as well as by an automatable laboratory working space as defined in claim 14.

Concerning the lid, the object of the invention is achieved by a lid for a microtiter plate, which has a plurality of cavities, which are arranged on a top of the microtiter plate and serve for receiving samples. The lid is securable, especially releasably, on the microtiter plate in such a manner that it covers at least the top of the microtiter plate. Furthermore, the lid has a basic body, which is embodied in such a manner that at least in regions, which are located above the cavities in the microtiter plate when the lid is on the microtiter plate, it is transmissive at least for light of at least one predeterminable wavelength. The lid includes, moreover, at least one closure element, which is embodied and/or arranged in such a manner that it closes at least one of the cavities in the microtiter plate when the lid is on the microtiter plate.

It is in this connection both an option that a single closure element is present, which closes the cavities in the microtiter plate. It is, however, likewise an option that a plurality of closure elements are present, each of which closes one or more cavities. The one or more closure elements are advantageously matched to the dimensioning of the lid and/or the dimensioning of the microtiter plate, especially in the region of the top of the microtiter plate.

Advantageously, the lid of the invention is at least partially transparent and, thus, light transmissive. Such is advantageous, for example, in connection with real time thermocyclers using optical systems for fluorescence measurement.

It is, on the one hand, an option that the entire lid is embodied transparent. Likewise it is, however, an option that individual components or portions of individual components, are embodied transparently. In this connection, numerous embodiments are possible, of which some especially preferred variants are given below.

In an embodiment, the basic body of the lid has a number of holes, wherein the holes are arranged in such a manner on the basic body that when the lid is on the microtiter plate they are located at least partially above the cavities. In this connection, it is, for example, an option that a hole is present in the basic body of the lid for each cavity in the microtiter plate. In such case, the holes can, for example, have the same diameter as the cavities. However, also different diameters for the cavities and the holes are an option. Preferably, the holes are arranged in such a manner that when the lid is on the microtiter plate they align with their cavities. It is, however, likewise possible that the number of holes and cavities be different. For example, a plurality of strip shaped holes can be arranged in the basic body of the lid, wherein each of the strip shaped holes is arranged above a plurality of cavities when the lid is on the microtiter plate.

Advantageously, an optical element, especially a lens, a filter, a slit or a grating, is arranged in at least one of the holes. The optical element can, in such case, be suitably selected for the contemplated application. Additionally, different lids with different optical elements can be used for different applications.

It is, however, likewise an option to arrange a transparent element, for example, a viewing window, in at least one of the holes.

Also, for the at least one closure element, numerous embodiments provide options. According to the invention, the closure element is embodied and/or arranged in such a manner that it closes at least one of the cavities in the microtiter plate when the lid is on the microtiter plate. The closure element is preferably so embodied that it covers at least one cavity of the microtiter plate when the lid is on the microtiter plate.

It is, in such case, both an option that the closure element simultaneously effects a sealing of the cavities from the surroundings. In such case, the closure element achieves a covering of the cavities as well as a sealing from the surroundings. It is, however, likewise an option that a component of the lid, for example, the basic body of the lid, is suitably embodied for achieving a sealing from the surroundings.

In an embodiment, the closure element is at least in regions, which are located above the cavities in the microtiter plate when the lid is on the microtiter plate, transparent at least for light of at least one predeterminable wavelength. Such is advantageous especially in combination with an embodiment of the lid having at least one opening.

A preferred embodiment provides that the closure element is a film, especially a self adhering film, or a silicone element.

Another preferred embodiment includes that the closure element is secured on a face of the basic body, which faces the microtiter plate when the lid is on the microtiter plate. For securing the closure element, many different variants provide options. The closure element can, for example, be adhered to or bonded on the basic body, especially by means of ultrasonic welding.

The closure element can, however, also be releasably secured on the basic body. Advantageously in this connection, the lid includes a securement element for securing the closure element on the basic body of the lid. The securement element can be, for example, an already existing or an additional component of the lid. For example, the closure element can be arranged and secured between the securement element and the basic body. In an embodiment, the securement element is a plate, which is matched to the dimensioning of the basic body. If the basic body has, for example, a plurality of holes, then the plate has likewise a plurality of holes. The closure element is, in this case, arranged between the basic body and the plate. In this embodiment, advantageously the plate is embodied in such a manner that it effects a sealing from the surroundings.

Another especially preferred embodiment includes that the closure element has an adhesive- and/or clinging layer on a side facing the microtiter plate when the lid is on the microtiter plate. The adhesive- and/or clinging layer can be embodied in such a manner that it directly provides an adhesive- and/or clinging action. It can, however, also be so embodied that the adhesive and/or adhesive action is achieved only under an external influence, especially a temperature and/or a force or ultrasonic oscillations. An adhesive- and/or clinging layer is especially advantageous when the closure element should also provide a sealing from the surroundings.

Another embodiment of the lid includes that the basic body of the lid is embodied pot shaped in such a manner that the basic body has a floor portion, which is matched to the dimensioning of the top of the microtiter plate, and wherein the basic body has extending essentially perpendicularly to the floor portion a lateral portion, which at least partially surrounds the microtiter plate when the lid is on the microtiter plate. The lateral portion can, in this case, serve as frame for the floor portion, in which the holes are arranged.

In another embodiment, the lid includes at least one spacer, which is embodied and/or arranged in such a manner that in a spacing position of the spacer the lid is arranged at a predeterminable distance from the microtiter plate or an additional lid when the lid is on the microtiter plate or on the additional lid, and the spacer is transferable into a closure position, in which the predeterminable distance is subceeded. In the closure position, the lid is on the microtiter plate in such a manner that the cavities of the microtiter plate closed and/or sealed from the surroundings.

The spacer enables, thus, a stacking on top of one another of a plurality of lids having the spacer of the invention or the stacking of lids and microtiter plates. In such case, the lid and microtiter plates can be arranged alternately on top of one another, without requiring that a microtiter plate already be closed with the lid. Moreover, the spacer serves for automating the procedure of closing a microtiter plate with a lid of the invention.

Advantageously, the spacer is transferable from the spacing position into the closure position by exerting a force, especially a vertical force. For example, a predeterminable limit value can be set for the force. Until this limit value is exceeded, the spacer remains in the spacing position; upon exceeding the limit value, in contrast, the spacer moves into the closure position. In such case, when the lid is on the microtiter plate, the lid closes the cavities of the microtiter plate in the closure position of the spacer. Advantageously, the transfer of the spacer from the spacing position into the closure position can be automated.

It is, in this regard, additionally advantageous that the spacer be provided with a securement element for securing the closure element between the basic body and the spacer.

It is likewise advantageous that the spacer comprise a holding element. The holding element is embodied in such a manner that at least the basic body and the securement element of the lid and/or the microtiter plate, or the other lid, are in contact with the holding element in the spacing position. In the closure position, into which the lid is transferred preferably only in connection with a microtiter plate, the lid is, in contrast, directly in contact with the microtiter plate. The holding element is in the closure position of the spacer preferably free of force, while in the holding position at least one force transmitted by the lid and/or the microtiter plate acts on the holding element.

Finally, advantageously, the space holder is arranged in the region of the lateral portion of the basic body and protrudes at least partially into an internal volume formed by the lateral portion. Especially, when the spacer has a support element, at least the support element reaches into the internal volume.

Finally another embodiment of the lid includes that the basic body has at least one formation, especially a formation arranged in the region of the lateral portion. Also the formation serves for automating the procedure of closing a microtiter plate with a lid of the invention, especially when the lid or lid and microtiter plates are stacked.

The object of the invention is achieved, furthermore, by a system comprising a microtiter plate and a lid of the invention.

Moreover, the object of the invention is achieved by an automatable laboratory working space comprising a system of the invention.

The automatable laboratory working space advantageously contains an apparatus for affecting temperature of a sample.

The laboratory working space is embodied in such a manner that a microtiter plate is closable with a lid of the invention. The closing of the microtiter plate can, in such case, occur outside or inside the apparatus affecting temperature of a sample. The apparatus affecting temperature of a sample is embodied in such a manner that the microtiter plate and the lid can be introduced into such.

Preferably used for the laboratory working space is a lid having at least one spacer of the invention. In such case, it is, on the one hand, an option that a robot be used, by means of which through execution of a force the spacer is transferable from the spacing position into the closure position. It is, however, likewise an option that the apparatus affecting temperature be embodied for transfer of the spacer from the spacing position into the closure position.

For example, the apparatus affecting temperature can comprise a heating system with a heating body, which has an intake region for receiving the microtiter plate and the lid, and a movable heating lid, which is arranged over the intake region of the heating body and embodied in the intake region of the heating body to press the microtiter plate and the lid in a heating position with a predeterminable compressive pressure. The spacer is then transferable from the spacing position into the closure position, for example, by means of a movement of the heating lid into the heating position. In the closure position, the lid closes the cavities in the microtiter plate.

The apparatus affecting temperature of a sample is preferably a thermocycler, a real time thermocycler, a thermoshaker, a microtiter plates reader, or an incubator.

It is to be noted here that the embodiments described in connection with the lid can be applied mutatis mutandis also for the microtiter plate of the invention and the laboratory working space of the invention and vice versa.

The invention as well as advantageous embodiments thereof will now be explained in greater detail based on the appended drawing, the figures of which show as follows:

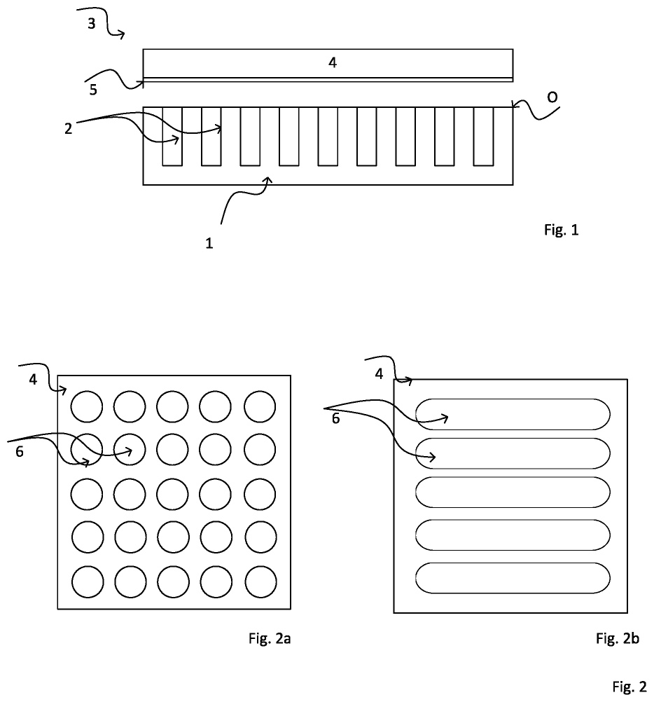

FIG. 1 a microtiter plate with a lid,

FIG. 2 two plan views of embodiments of the lid with holes,

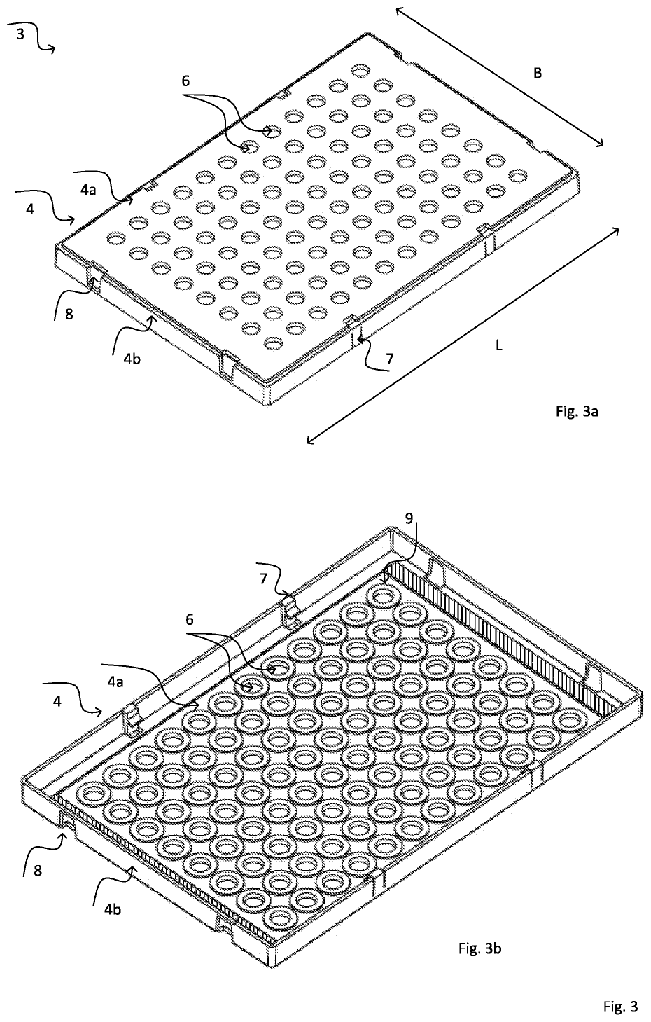

FIG. 3 a preferred embodiment of a lid of the invention having a basic body comprising a floor portion and a lateral portion as well as a spacer,

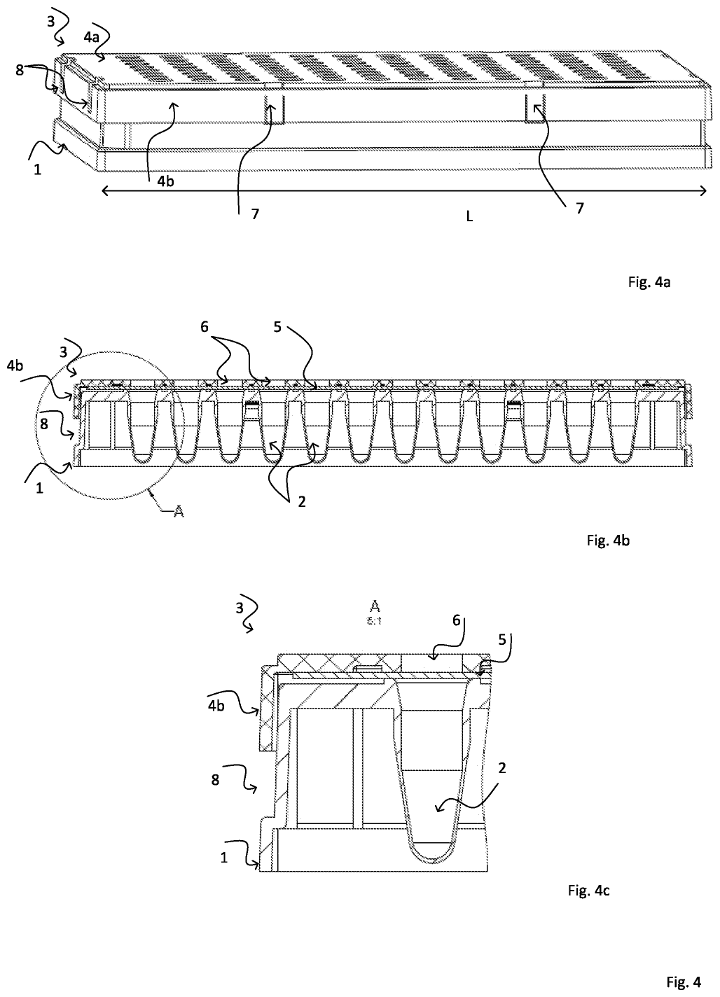

FIG. 4 the microtiter plate and the lid of FIG. 3, wherein the lid is applied on the microtiter plate, with a detail view of the formations,

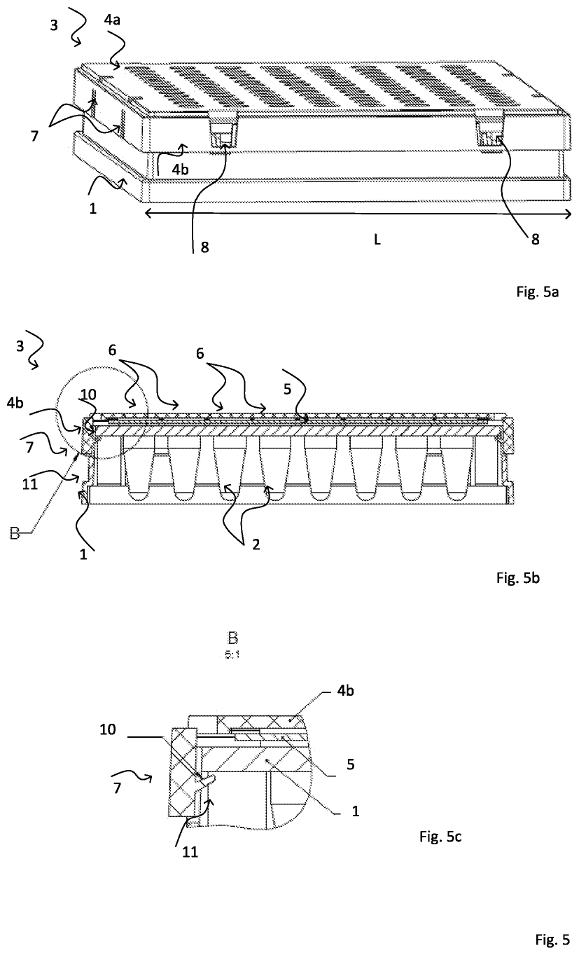

FIG. 5 the microtiter plate and the lid of FIG. 3, wherein the lid is on the microtiter plate, with a detail view of the spacer.

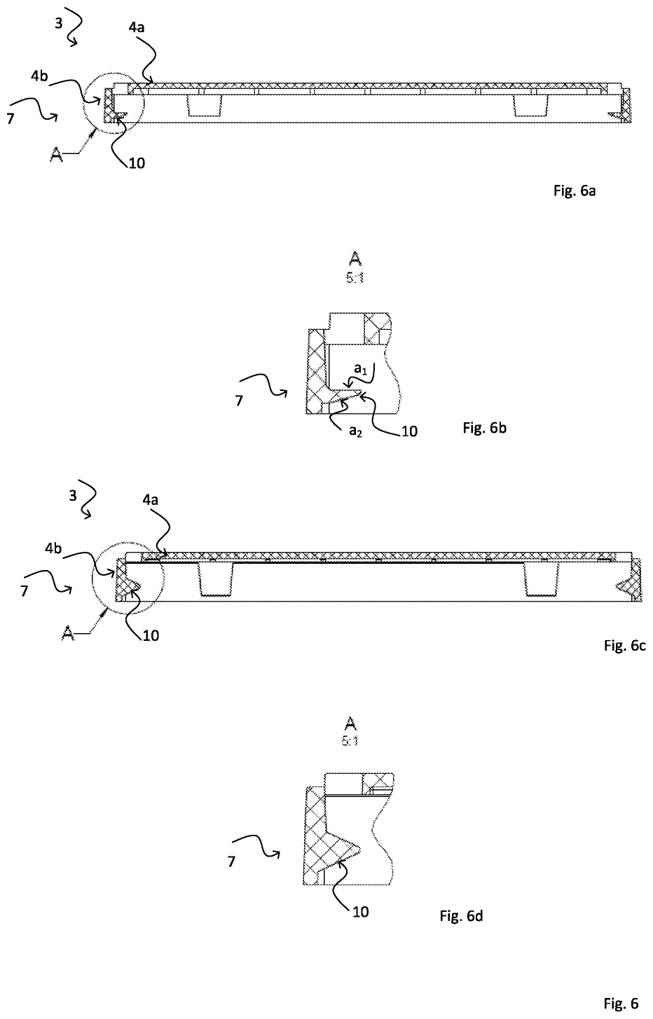

FIG. 6 two embodiments of the spacer,

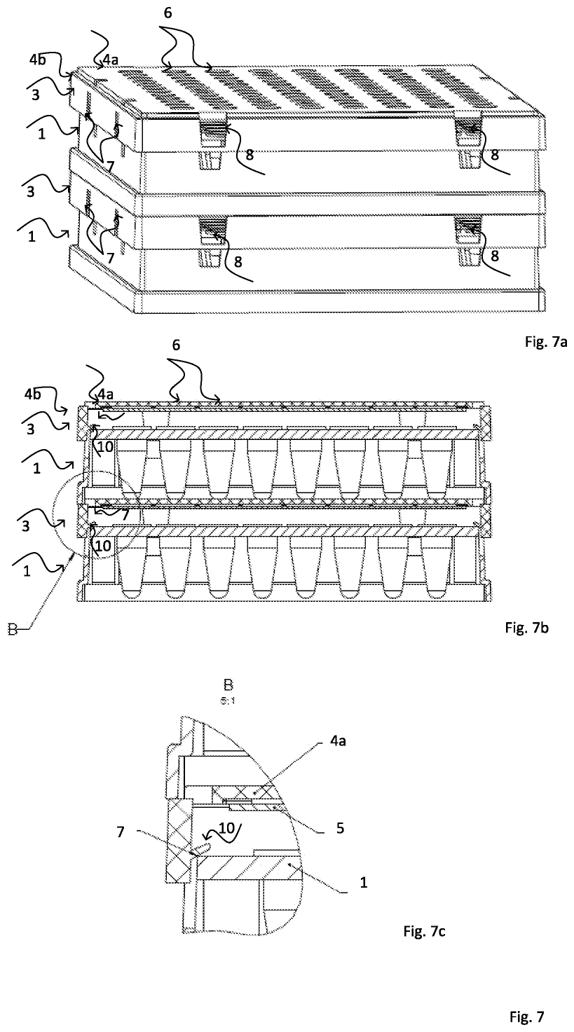

FIG. 7 a stack of sequentially following lids and microtiter plates of FIG. 5, superimposed by means of the spacer, and

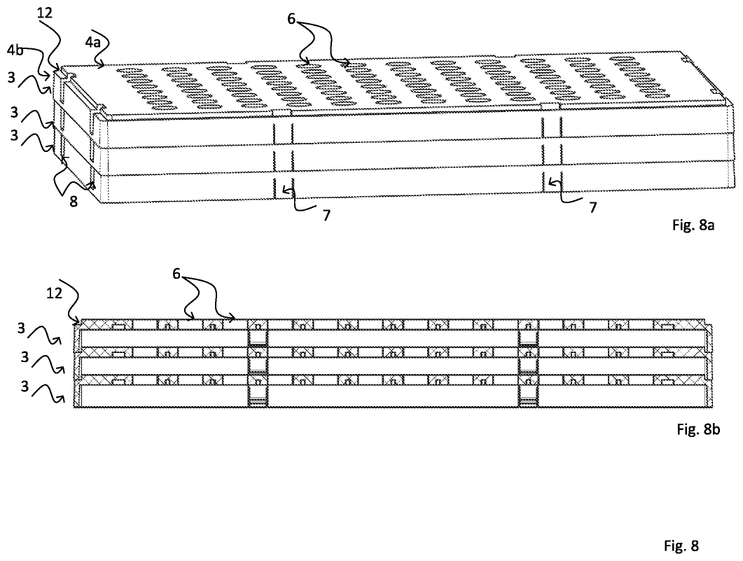

FIG. 8 a stack of sequentially following lids.

In the figures, equal elements are provided with equal reference characters.

FIG. 1 shows a microtiter plate 1, on whose top O a plurality of cavities 2 are arranged for receiving samples. Above the microtiter plate 1 is a lid 3 of the invention having a basic body 4 and a closure element 5. The closure element 5 is matched to the dimensioning of the basic body 4 and embodied in the form of a film, which is secured on the basic body 4. When the lid 3 is secured on the microtiter plate 1, the cavities 2 are closed by the lid and sealed from the surroundings. According to the invention, the basic body 4 of the lid 3 is at least partially transmissive for light of at least one predeterminable wavelength, especially in regions, which are located above the cavities 2 in the microtiter plate 1 when the lid 3 is on the microtiter plate 1. The lid 3 is, preferably, thus, at least partially transparent. In this embodiment, the basic body 4 as well as the closure element 5 are completely transparent.

Two other possible embodiments of the lid 3 are shown in FIG. 2. Shown, in each case, is a view of the basic body 4 of the lid from above. In both embodiments, a plurality of holes 6 are arranged in the basic body. The holes 6 are, in such case, arranged in such a manner that they are above the cavities 2 of the microtiter plate when the lid 3 is on the microtiter plate 1. In the embodiment of FIG. 2a, the number of holes 6 corresponds to the number of cavities 2, wherein the holes 6 align with the cavities 2 and have equal diameters. In the case of the embodiment of FIG. 2b, the number of holes 6 is, in contrast, less than the number of cavities 2. In such case, in each case, a hole 6 is arranged over a row of cavities 2 in the microtiter plate 1. Arranged in the holes 6 can be, for example, viewing windows, or optical elements.

Shown in FIG. 3 are two perspective views of an additional embodiment of a lid 3 of the invention with spacers 7 and formations 8. FIG. 3a shows a view of the lid 3 from above, and FIG. 3b a view from below. The basic body 4 of the lid includes in this case, a floor portion 4a and a lateral portion 4b, wherein the spacers 7 and formations 8 are both arranged in the region of the lateral portion 4b. In the case of the illustrated embodiment, the lid includes four spacers 7 and four formations 8, wherein the spacers 7 and formations 8 are, in each case, arranged pairwise on mutually opposite sides of the lateral portion 4b. In such case, the spacers 7 are, in each case, arranged on a side of the lateral portion 4b in parallel with the longitudinal axis L and the formations 8, in each case, on a side of the lateral portion 4b in parallel with a breadth axis B.

The shown arrangement and number of spacers 7, and formations 8, are, however, not limiting. Thus, the number of spacers 7, and of formations 8, and/or the arrangement of the same, can be different in other embodiments.

As evident from FIG. 3b, the floor portion 4a is, furthermore, embodied in a region, which faces the top O of the microtiter plate 1 when the lid 3 is on the microtiter plate 1, to seal from the surroundings. To this end, a circularly shaped sealing element 9 is provided at each of the holes 6. This embodiment of the floor portion 4a is, however, not absolutely necessary. A sealing from the surroundings can also be achieved, for example, by the closure element 5 (not shown here).

Shown finally in FIG. 4 are the microtiter plate 1 and the lid 3 of FIG. 3, wherein the lid 3 is secured on the microtiter plate 1. FIG. 4a shows a front view in parallel with the longitudinal axis L of a system formed of the microtiter plate 1 and the lid 3. An enlarged sectional illustration is shown FIG. 4b. The lid 3 is secured on the microtiter plate 3. The holes 6 in the lid 3 are arranged above the cavities 2 in the microtiter plate 1, wherein the cavities 2 are closed by the closure element 5. An enlarged view of area A of FIG. 4b is shown in FIG. 4c. The formations 8, here in the form of windows, enable in the case of an arrangement of lids 3 and microtiter plates 1 or of lids 3 in a stack a simplified, especially automatable, handling of the lid 3. The formations 8 serve especially for automated withdrawal of an individual lid 3 from a stack and placement thereof on a microtiter plate 1.

FIG. 5 shows an illustration corresponding to that shown in FIG. 4 of the microtiter plate 1 and the lid 3 in a view in parallel with breadth axis B. FIG. 5a shows, such as in FIG. 4a, a schematic drawing, while in FIG. 5b an enlarged sectional illustration is shown. The spacer 7 includes a holding element 10, which protrudes into an internal volume of the lid 3 formed by the lateral portion 4b. An enlarged view of the region of FIG. 5b labeled with letter B is shown in FIG. 5c. The spacer 7 is located in the illustration shown in this case, in the closure position P2. In this embodiment, the holding element 10 protrudes in this position P2 without resistance into a corresponding hollow 11 of the microtiter plate 1. A hollow 11 in the microtiter plate 1 is, however, not necessary for the present invention. For other embodiments of the spacer 10, which can use a clamping mechanism, for example, such a corresponding hollow 11 is not required in the microtiter plate 1.

It is to be noted here that an arrangement of the spacer 7 in parallel with breadth axis B and an arrangement of the formations in parallel with the longitudinal axis L are not required in the context of the present invention. Rather, also other arrangements are possible and fall within the scope of the present invention. Such is also the case with respect to the number of spacers 7 and formations 8. In the embodiment shown here, four spacers 7 and four formations 8 are used. Another number of spacers 7 and/or formations 8 is, however, likewise possible.

Shown in FIG. 6 are two other embodiments for a lid 3 of the invention with spacers 7 each having a holding element 10. In both embodiments, the spacer 7 is located in a neutral position P3. The spacer 7 is located in this position P3, for example, when the lid 3 is not on a microtiter plate 1, for example, in the case of an arrangement of plurality of lids 3 on top of one another in a stack, such as shown in FIG. 8. In the embodiment of FIGS. 6a and 6b, the holding element 10 is stylus shaped, wherein a region a₁ of the holding element 10 facing the floor surface 4a of the lid 3 extends in parallel with floor surface 4a of the lid 3, while the floor surface 4a far region a₂ of the holding element 10 is so embodied that a diameter of the holding element 10 decreases with growing distance from the lateral portion 4b of the lid 3. The region a₁ facing the floor surface 4a of the lid 3 can especially have an at least partially planar area, which in the closure position P2 of the lid 3 lies essentially flushly against the microtiter plate 1. In the embodiment of FIGS. 6c and 6d, in contrast, the holding element is conically embodied and has no planar area extending in parallel with the floor portion 4a. As already mentioned, the spacer can, however, also be embodied without a corresponding holding element 10. For example, it can use a clamping mechanism for securing the lid 3 on the microtiter plate 1.

FIGS. 7 and 8 illustrate advantages of the present invention relative to automated handling and relative to the stackability of lids 3 of the invention, or of systems composed of alternating microtiter plates 1 and lids 3.

FIG. 7 shows a stack of two microtiter plates 1 and two lids 2, which follow one another alternatingly. FIGS. 7a and 7b are schematic drawings, while FIG. 7c is an enlarged view of the region B of FIG. 7b. The microtiter plates 1 and lids 3 are embodied analogously to FIG. 4, or FIG. 5, as the case may be. In contrast to FIG. 5, however, the holding element 10 of the spacer 7 is located, in each case, in the spacing position P1 and lies on the microtiter plate 1.

FIG. 8 shows a stack of three lids 3 arranged on top of one another. FIG. 8a shows a perspective view of the stack, while in FIG. 8b a sectional illustration is shown. The floor portion 4a and the lateral portion 4b of each lid 3 are embodied and/or arranged relative to one another in such a manner that in the margin of the lid 3 an edge 12 is present. The edge 12 is embodied, for example, in the form of a step, whose width is matched to the thickness of the wall of the lateral portion 4b. A stacked lid 3 can, thus, be supported on the edge 12 of the lid 3 below. The edge 12 can, such as in the embodiment of FIG. 8, on the one hand, extend completely around the floor portion 4a of the lid 3. It is, however, also an option to provide such an edge 12 only along two opposite sides of a lid 3.

The formations 8 extend in the illustrated embodiment from the lateral portion 4b through the edge 12 to the floor portion 4a. It is understood, however, that also other embodiments of the formations 8 are possible and fall within the scope of the present invention. Regarding the spacer 7 (here not shown in detail), it is, again, to be noted that in the case of an embodiment such as shown in FIG. 5 or FIG. 6 the holding element 10 is located in the case of an arrangement of a plurality of lids 3 in the form of a stack, in each case, in the neutral position P3.

The solution of the invention thus, enables, in simple manner, a stacking of either a plurality of microtiter plates 1 or lids 3 on top of one another or the alternating stacking of the plurality of microtiter plates 1 and lids 3 on top of one another.

### REFERENCE CHARACTERS

1 microtiter plate
2 cavities
3 lid
4 basic body
4a floor portion
4b lateral portion
5 closure element
6 holes
7 spacer
8 formation in the lid
9 closing element
10 holding element
11 hollow in the microtiter plate
12 edge
L longitudinal axis
B breadth axis
O top
a₁,a₂ regions of the holding element
P1 spacing position
P2 holding position
P3 neutral position

1-15. (canceled)

16. A lid for a microtiter plate, which has a plurality of cavities, which are arranged on a top of the microtiter plate and serve for receiving samples,
wherein the lid is securable on the microtiter plate in such a manner that it covers at least the top of the microtiter plate,
wherein the lid has a basic body, which is embodied in such a manner that at least in regions, which are located above the cavities when the lid is on the microtiter plate, it is transmissive at least for light of at least one predeterminable wavelength, and
wherein the lid includes at least one closure element, which is embodied and/or arranged in such a manner that it closes at least one of the cavities in the microtiter plate when the lid is on the microtiter plate.

17. The lid as claimed in claim 16,
wherein the basic body of the lid has a number of holes, wherein the holes are arranged in such a manner on the basic body that when the lid is on the microtiter plate they are located at least partially above the cavities.

18. The lid as claimed in claim 17,
wherein an optical element is arranged in at least one of the holes.

19. The lid as claimed in claim 16,
wherein the closure element is at least in regions, which are located above the cavities in the microtiter plate when the lid is on the microtiter plate, transparent at least for light of at least one predeterminable wavelength.

20. The lid as claimed in claim 16,
wherein the closure element is a film.

21. The lid as claimed in claim 16,
wherein the closure element is secured on a face of the basic body, which faces the microtiter plate when the lid is on the microtiter plate.

22. The lid as claimed in claim 16,
wherein the closure element has an adhesive- or clinging layer on a face facing the microtiter plate when the lid is on the microtiter plate.

23. The lid as claimed in claim 16,
wherein the basic body is embodied pot shaped in such a manner that the basic body has a floor portion, which is matched to the dimensioning of the top of the microtiter plate, and wherein the basic body has extending essentially perpendicularly to the floor portion a lateral portion, which at least partially surrounds the microtiter plate when the lid is on the microtiter plate.

24. The lid as claimed in claim 16,
comprising at least one spacer, which is embodied and/or arranged in such a manner that, in a spacing position of the spacer the lid is arranged at a predeterminable distance from the microtiter plate or an additional lid when the lid is on the microtiter plate or the additional lid, and
the spacer is transferable into a closure position, in which the predeterminable distance is subceeded.

25. The lid as claimed in claim 24,
wherein the spacer is transferable from the spacing position into the closure position by exerting a force.

26. The lid as claimed in claim 23,
wherein the space holder is arranged in the region of the lateral portion of the basic body and protrudes at least partially into an internal volume formed by the lateral portion.

27. The lid as claimed in claim 28,
wherein the basic body has at least one formation.

28. A system comprising a microtiter plate and a lid comprising:
a lid for a microtiter plate, which has a plurality of cavities, which are arranged on a top of the microtiter plate and serve for receiving samples,
wherein the lid is securable on the microtiter plate in such a manner that it covers at least the top of the microtiter plate,
wherein the lid has a basic body, which is embodied in such a manner that at least in regions, which are located above the cavities when the lid is on the microtiter plate, it is transmissive at least for light of at least one predeterminable wavelength, and
wherein the lid includes at least one closure element, which is embodied and/or arranged in such a manner that it closes at least one of the cavities in the microtiter plate when the lid is on the microtiter plate.

29. An automatable laboratory working space comprising:
a lid for a microtiter plate, which has a plurality of cavities, which are arranged on a top of the microtiter plate and serve for receiving samples,
wherein the lid is securable on the microtiter plate in such a manner that it covers at least the top of the microtiter plate,
wherein the lid has a basic body, which is embodied in such a manner that at least in regions, which are located above the cavities when the lid is on the microtiter plate, it is transmissive at least for light of at least one predeterminable wavelength, and
wherein the lid includes at least one closure element, which is embodied and/or arranged in such a manner that it closes at least one of the cavities in the microtiter plate when the lid is on the microtiter plate.

30. An automatable laboratory working comprising:
a lid for a microtiter plate, which has a plurality of cavities, which are arranged on a top of the microtiter plate and serve for receiving samples,
wherein the lid is securable on the microtiter plate in such a manner that it covers at least the top of the microtiter plate,
wherein the lid has a basic body, which is embodied in such a manner that at least in regions, which are located above the cavities when the lid is on the microtiter plate, it is transmissive at least for light of at least one predeterminable wavelength,
wherein the lid includes at least one closure element, which is embodied and/or arranged in such a manner that it closes at least one of the cavities in the microtiter plate when the lid is on the microtiter plate, and
an apparatus affecting temperature of a sample.
